(19) United States
(12) Patent Application Publication
(10) Pub. No.: US 2003/0169289 A1
(43) Pub. Date: Sep. 11, 2003

(54) Dynamic software control interface and method

(76) Inventors: Duane Anthony Holt, Orlando, FL (US); Randy C. Krull, Apopka, FL (US); James M. Hunter, Redmond, WA (US)

Correspondence Address: Duane A. Holt, Apt. 1305, 2729 Maitland Crossing Way, Orlando, FL, 32810, US

(21) Appl. No.: 10/093,674

(22) Filed: Mar. 8, 2002

(51) Int. Cl. G09G 5/00

(52) U.S. Cl. 345/735

(57) ABSTRACT

A software interface that is installable on a processor for interfacing with an electrically or electronically controllable device. The software comprises means for receiving input from a user remotely via a network and a means for translating the network communicated user input into at least one of a control signal and a configuration signal. The software interface further comprises means for communicating a control signal to control software. Such control software, which is already known in the art, is configured in controlling relation to at least one of an electrically or electronically controllable device through a hardware interface. Further, means are included for translating a configuration signal into a user interface application between the control software and an indicator displayable to the user; means rendering a dynamic user interface in response to changes in connected devices; and means for ensuring the reliable relay of command and configuration signals across unreliable networks susceptible to limited bandwidths and communication interruptions.

### BACKGROUND OF INVENTION

1. Field of the Invention

The present invention relates to interfaces between a user and a device or plurality of devices, and more particularly, to software interfaces for controlling and displaying the current status of components across a network.

2. Description of Related Art

The concept of a unified, adaptive automation for a site comprising a plurality of controllable devices has yet to be achieved under software control across computer networks utilizing standard Internet protocols.

Interfaces existing between, for example, a user and devices are known in the art, such as those comprising circuits for controlling a plurality of devices (U.S. Pat. Nos. 5,684,449 and 5,995,877), remote control units, such as those used to control audio-visual equipment (U.S. Pat. Nos. 5,729,222, 5,793,300, 5,903,226, and 6,211,870). Software interfaces such as the commercially available SYS are also known that reside within a computer and connect through a hardware device such as the commercially available Panga interface to wiring leading to controllable devices.

Most controls required the operation of a hardware device with the user in close proximity to the devices controlled. Such as a standard remote control, or universal remote controls limited by either the range of the infrared transmitter or a low powered radio transmitter. The latest in remote control technology that has been successful in the commercial market place uses a remote with a processor unit and a touch screen display that allows the user to customize the displayed buttons on their remote with the aid of a specialized computer program. This customization allows the user use a computer program to design very simple graphics in a button format, associate predetermined remote control commands to these buttons, and design a predetermined screen layout of multiple buttons that will display on their remote, and save these files on their computer. Then the user is required to physically connect their remote control device to the computer where the electronic files are available, run a software routine that will copy these files to their remote control unit thus making the remote control's user interface customizable.

Those controls that do not require close proximity require a user to utilize a system of hardware and control different than a user's preferred interface for controlling components while in close proximity, and are not dynamic and extendable systems. There are known systems for controlling a particular device remotely, such as videocassette recorders that are programmable over the phone. These systems are not adaptable, nor extendible to a plurality of controllable devices.

More specific to the home automation market there are user interface devices that exist that enable a touch screen display to present graphics that represent controls that are translated by a processor into control signals to control a device. Some of these displays have feature of custom graphics such as the AMX Viewpoint RTM and Crestron ISYS RTM touch panel displays. These touch panels have the requirement to be in close proximity of their system either because of hardwiring or radio transceivers that communicate to a device for processing the control signals sent and received through the system. These control signals are either proprietary in the hardware and/or the communication protocols that are short ranged and thus require the user interface hardware to be in close proximity to the receiving unit that processes and translates the signal. In addition these components require the custom graphics software package that use a proprietary language for development of user interface (AMX: VPXpress ViewPoint System Design/Programming Software Program, and Crestron: SIMPL). When developing a custom interface using these development languages the user is required to create the graphical representation of the button or control, and also create a software program functions to enable that control to send a control signal to a destination device. Normally this requires skills in two different arts: Graphic Design and Software Programming, and requires a specialized training. Depending on the complexity of the functions desired and the individual command set required, the system might require skills in other arts as well in order to correctly generate the correct control commands. Once the graphics and program code associated with the graphics are complete, they must be transmitted from the host PC where the content is authored to the touch screen system and remain resident in that system. Any change in the user interface graphic display would require a repeat of this authoring process.

Network enabled software that presents a user interface to enable the remote control of a connected device is also known to exist, such as the TrakerCam RTM, which is a tripod with embedded control mechanisms to rotate and control a camera connected to a personal computer. These kinds of network enabled software control systems are dedicated to the control of their devices, and do not provide the user a programmable software interface to control a plurality of devices, and are not extendable to control devices with control codes yet unknown, and are not dynamic in their ability to automatically display graphical icons of newly connected components without accepting user input in the graphical user interface software.

In addition to the limitations of extendibility, a reliability issue exists when a network enabled software to control and display information about controlled devices. An example is using a user interface in a web browser across the public Internet because the architecture of the web. The Internet is comprised of multiple companies with interconnected networks that make the Internet possible. Each company is responsible for providing a part of the path that comprises the connection between two different computers on the Internet. Add to this that the protocols used to establish and exchange information across the web's HTTP protocol was designed to be a browsing technology, and does not provide the fault tolerance or redundancy required in a long term, two-way communication connection between the user interface and hardware device controlled by that user interface. A long time user of the World Wide Web has probably experienced this unreliability especially during peak hours of use usually in the late afternoon and early evenings. This type of unreliability can manifest itself as a frustrating user experience and symptoms may include web pages that have missing pictures, pages that only have part of the page loaded and abruptly ends, or worst of all a page that never loads in which the web browser continues to present to the user some sort of status that appears as if the web pages is loading into memory. Usually this requires the user to use the refresh commands or to navigate to the website again. This is typical during high bandwidth usage in which a connection is lost or terminated early, or when the initial request from the user's web browser to the website is lost during peaks of network congestion at some point across the Internet. This congestion is usually managed by various network operators across the Internet and can last from fractions of a second to periods of minutes to hours. Normally a web browser sends the request only once, and if this request isn't received or is abnormally terminated during these peaks of use, the result is usually a not so pleasant user experience of half loaded web pages information requests such as online catalog browsing or checkouts that never complete. Experts with experience in database programming and web page programming have identified these user problems, and as a result a user will sometimes see requests on check out pages that read something similar to the following when making an online purchase: Do not hit your back button or refresh button as your credit card may be charged twice. These same issues can also exist on a local, close proximity network in the home where the communication may be subject to interference from common household devices. In the case of a typical home computer network that is wired, or a radio network (WI-FI, 802.11b), interference that can interrupt communications on the network can be received by devices such as unshielded florescent bulb housings, microwave ovens, unshielded computer cases, televisions, high voltage power cords, power transformers, and wireless transmitters and receivers such as room to room television, wireless headphones, and wireless telephones. Network interference can significantly reduce the communication bandwidth and reliability, and devices designed for display and control of devices work around this issue by putting most if not all of the programming logic and graphical display information in a static memory or storage on the hardware device that displays the graphical user interface. This reduces the amount of network communication needed by requiring only the Identification of the controlling device and control command to be sent across the network, but results significant disadvantages as well.

In addition to the network communication problems created by using standard internetworking protocols, there is a bandwidth issue with a majority of internet connected PCs. A majority of PCs in the U.S. still use dialup modem connections to the Internet that have a severely limited bandwidth. Add to this the analog signal that travels across standard modems is also susceptible to interference which can drastically reduce the available bandwidth, and this issue is severe especially for those that would implement a system to control and monitor connected devices via a portable PC with a modem from an unknown location while traveling such as a hotel. The current teachings in the art of web site design for a website or software system to be accessed across the Internet take these types of changes in bandwidth and connection speeds into account by encourages the use of compressed bitmap format such as JPG images to fill graphic elements on the page. Further the artist or engineer is to check each individual page for total size so that the total download time is excessively large, or to allow the user to choose larger graphics file sizes for better quality images, if they have a high bandwidth connection.

### OBJECTS AND ADVANTAGES

It is therefore an object of the present invention to provide an interface for remote controlling a plurality of devices having multiple control parameters.

It is another object to provide such an interface that is software based.

It is another object to provide an interface that is network enabled.

It is another object to provide an interface that is dynamic..

It is another object to provide such an interface that can access external data in addition to the user communications.

It is another object to provide the user an interface based on vector graphic elements.

It is another object to provide such a user interface that can be displayed in a standard web browser such as Microsoft's Internet Explorer RTM, or Netscape RTM.

It is also an object to provide a programming interface that enables the existing user interface to be extended to control devices that are functionally similar, when these new devices are added to the system, without the reinstallation of the software, even when the new device would require the creation or installation of a new software to enabled signal communications to the device.

It is yet another object to create a user interface that is more reliable when used across the Internet than standard web applications, especially when networking communication maybe unreliable.

The advantages of the system are numerous over existing systems available for device control and include the following.

There is a user interface that can be customized by anyone familiar in the art of graphics or multimedia design. A different interface can be presented by user preference if the system is configured to recognize different users.

The user interface can be displayed using any standard web browser using standard Internet protocols allowing the user to access the user interface anywhere there is an available network connection to the system. Since the user interface uses standard internet browser technology, and standard network technology, proprietary hardware or software processing is not required to display the user interface such as those required with existing automation systems.

With the present invention a software payload is delivered as part of the user interface when it is first displayed in the web browser. This payload is the communication piece that includes components designed to compensate for the unreliability network communications, and is only delivered once across the network, slightly increasing the connection time when the user first initializes the user interface. When the user dicks on a control the command is queued and will be retried across the network until the connection and communication is successful. Another benefit is enabling of a display of the present state of communications, even while the user is doing nothing, allowing the user to see the current reliability of communications across the network.

The current invention also allows the system to be extended through an application programming interface, more commonly known as an API, to allow the user or other third parties to develop a piece of software to allow the user interface to display data and control other software, devices, or controls. This is an event driven two way communication API that achieves the stated object of allowing the system to be extended to devices which are similar in functionality to devices already controlled by the system, but which may or may not be currently supported by the system. A third party can easily add custom software to enable these communications and the system will the newly connected device and automatically display this control in the user interface to enable display of status and control of the device with the appropriate icon.

Another advantage of the software is the process for creating completely new user interface elements. The most popular software programs that exist today are those that allow the end user and third parties that are graphic design experts customize or create new skins for presentation of the user interface. These are most successful when there are no programming requirements to replace or create new graphic elements. Some examples include the ability to replace the bitmap picture that is the desktop of the Windows RTM operating systems, and the hundreds if not thousands of user created skins available on the Winamp.com website for the a digitized music player for WinAmp RTM. This software accepts customized graphical multimedia elements that are just as easy for users with graphic arts experience to create, with no programming required.

Another benefit of the design of the software system is that these custom graphics only need to be loaded into the base system on a generic class bases. An example class might be an on/off switch. The software system will automatically create individual instances of this new graphic in the user interface for every on-off type device available to control. In addition since the user interface elements can be authored individually the user duplicate and customize an existing user interface by simply copying all the file based elements of the system and only editing the class files for each element they would like to change. Additionally since this method was achieved using a multimedia vector based graphics language, the icons do not need to be static. Each interface element class can contain any type of multimedia element supported, such as sound and animation.

There are other benefits of using a vector graphics system instead of bitmap graphic system across the Internet. The first is fast; often instantaneous downloads of new graphic components even across slow modem based connection due to the drastically reduced file size required by vector graphics formats when describing icons, drawings, and animations. Another benefit of vector graphics is that the graphics are device independent and are scalable. This means that graphics defined in the user interface will be the same for any device display even if they have different resolutions and sizes. A full screen display on a television will be the same full screen display on a laptop PC, and on a desktop PC with a 15″ monitor.

The system also has a system for configuring the display of each graphical element such as X-Y position, and stores this information in the database, and thus allows the user to control the arrangement of each graphical element or icon.

Because the user may use a device as small as a 2 or 3″ screen on a portable device such as a PDA. This device's limited screen size and resolution is easily accommodated by the loading mechanism for each graphic. Because the vector graphics format is scalable, the only function required is to adjust the number of icons displayed, typically only one or two at a time.

For the end user the result is an adaptable system that enables an easily customized user interface with graphics and multimedia icons of their choice. In addition those custom graphics are available as their user interface anywhere and everywhere there is an available device capable of browsing and displaying standard Internet content. This user interface will be the same no matter what device they use. Further the browsing experience for the end user is a more reliable, and faster experience compared to standard web applications and includes functional enhancements such as the user only needs to click once to send a command, and can dynamically receive updated information from their system of devices with no user input required by just leaving the user display open in the browser. For early adopters, hobbyists, third-party programmers, and others who are interested, there also exists a programmatic interface to extend the display and control beyond the currently available devices in the current system allowing development of custom content providers and other customizations after installation.

These objects and others are achieved by the present invention, a software interface installable on a processor for interfacing with an electrically or electronically controllable device. The software interface comprises means for receiving input from a user remotely via a network and a means for translating the network-communicated user input into at least one of a control signal or configuration signal. The software interface further comprises means for communicating a control signal to control software. Such control software, which is known in the art, is configured in controlling relation to at least one of an electrically or an electronically controllable device through a hardware interface. Further, means are included for translating a configuration signal into a user interface application between the control software and an indicator symbol displayable to the user.

The features that characterize the invention, both as to organization and method of operation, together with further objects and advantages thereof, will be better understood from the following description used in conjunction, with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### SUMMARY OF INVENTION

A software interface installable on a processor for interfacing with an electrically or electronically controllable device that can be accessed via standard network interface for browsing the Internet and can render a dynamic software control user to accept user input to control the connected devices and dynamically generate a display of the current status of connected devices.

### DRAWINGS

### BRIEF DESCRIPTION OF DRAWINGS

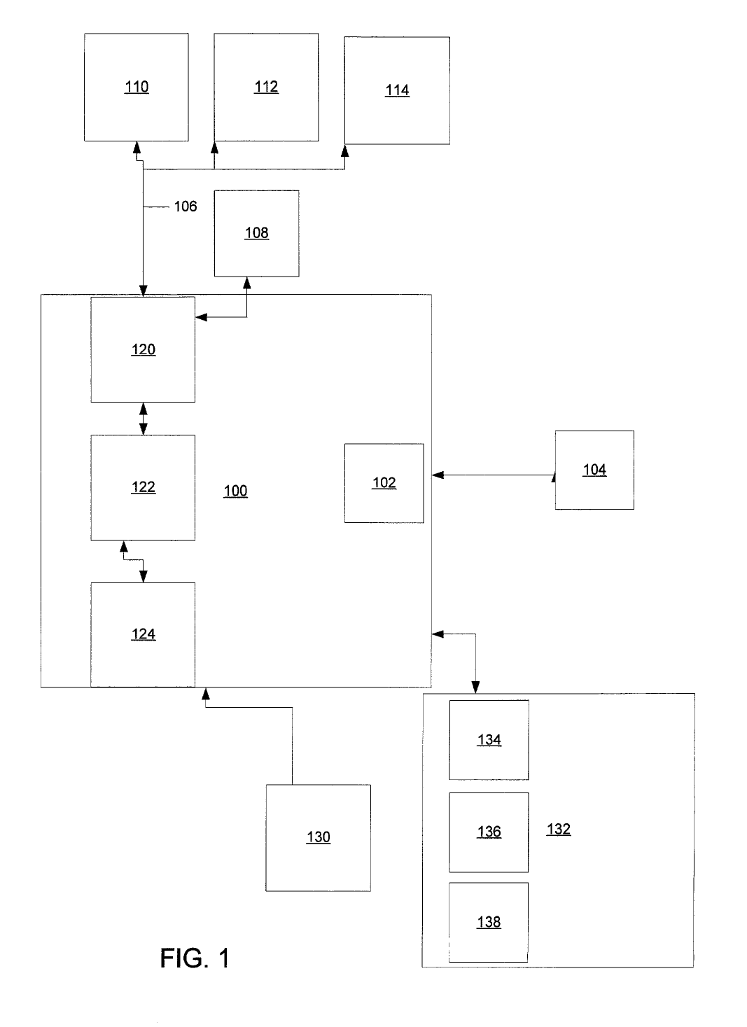

FIG. 1 is a schematic diagram of a particular embodiment of the interface system of the present invention.

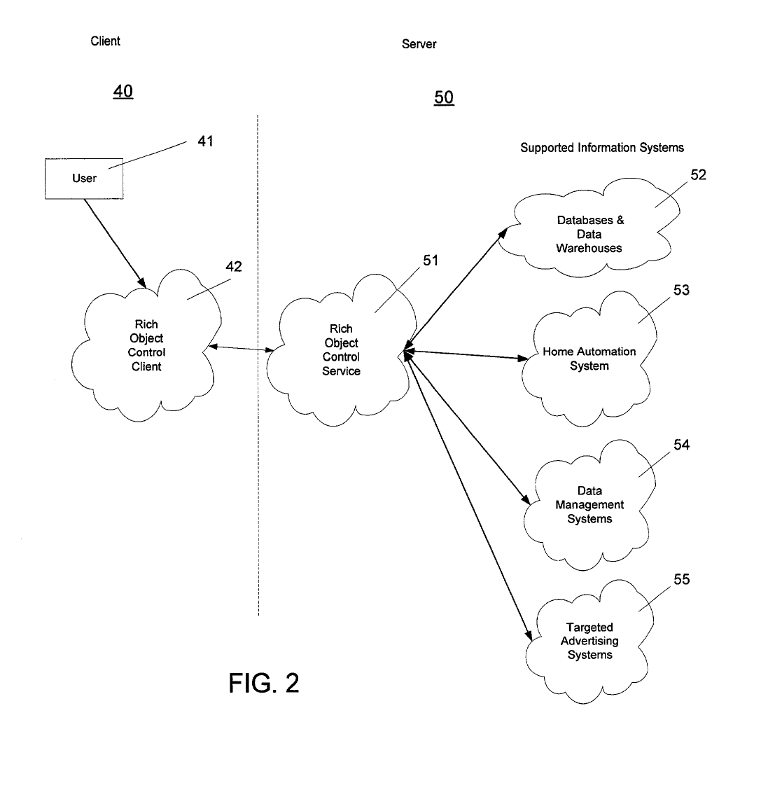

FIG. 2 is a schematic diagram of the general layout of the present invention.

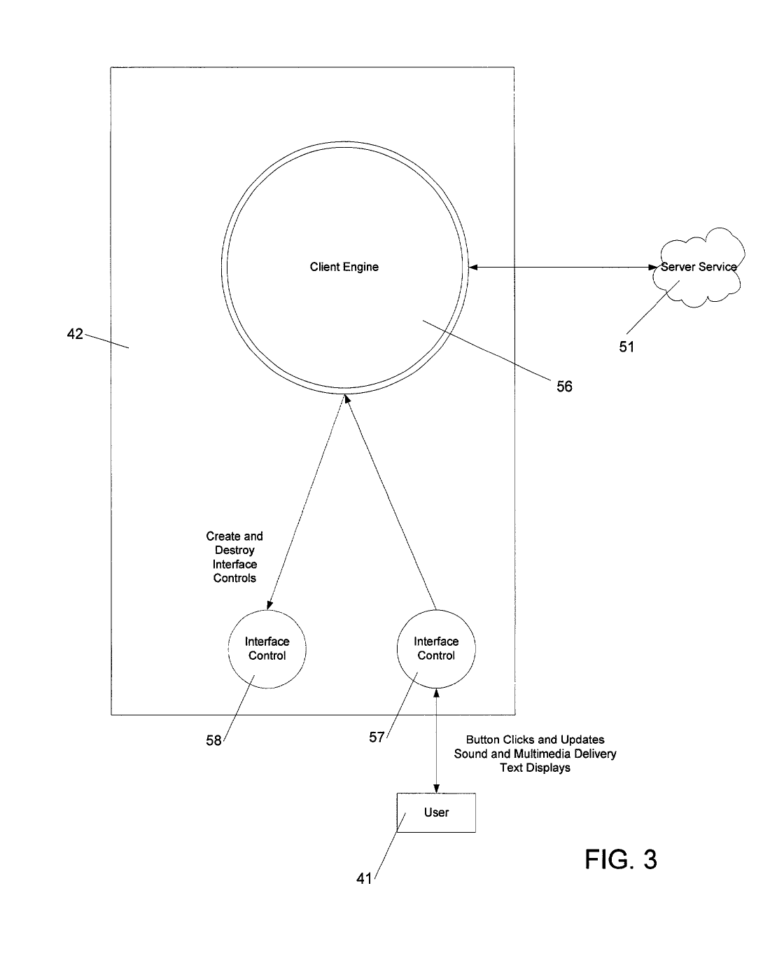

FIG. 3 is a schematic diagram of the client engine.

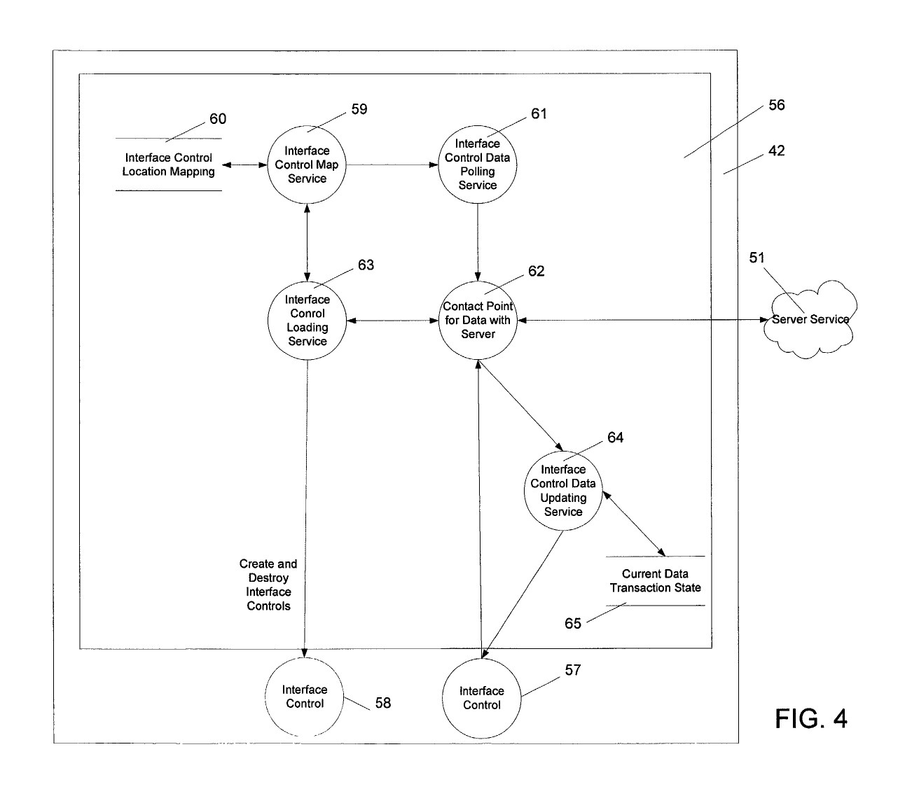

FIG. 4 is a more detailed schematic diagram of the client engine.

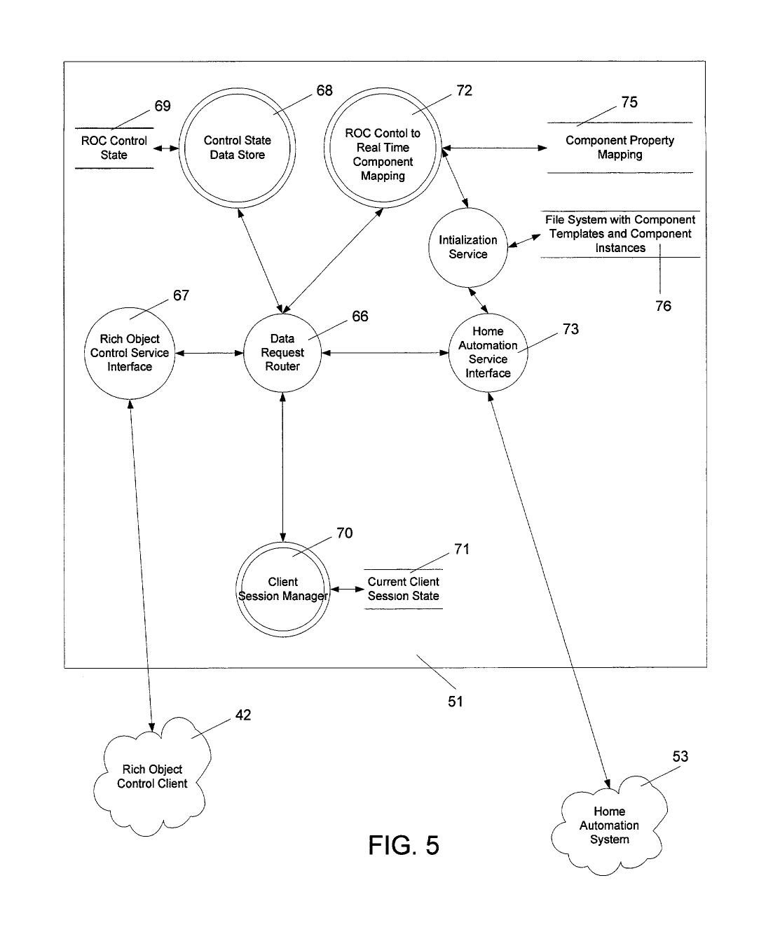

FIG. 5 is a schematic diagram of the rich object control service.

### DETAILED DESCRIPTION

Preferred Embodiments

A description of the preferred embodiments of the present invention will now be presented with reference to FIGS. 1-5.

FIG. 1 shows an embodiment that comprises an application for building automation, such as a home, although this is not intended as a limitation. In this embodiment the software server software 122 and the client software 124 of the present invention resides on a computer 100 having means, such as a modem or network card 102, for accessing a network 104 such as the Internet, data from which may be used to control elements of the system or to serve as an information source. It is to be understood by one of skill in the art that the word computer should be taken to mean a device comprising a processor, memory, and an operating system capable of accepting input from devices such as keyboard, mouse, or touch pad, and displaying output to devices such as a video monitor or LCD screen.

The computer 100 also is in electronic communication with an output device such as video monitor 132, at least one input device such as a keyboard, pointing device, or touch screen 130, and one or more signal-communication means such as an electrical wire 106 and/or a device for signal-communications without a wire such as a light or radio frequency transmitter/receiver 108.

The software interface 122 is adapted to build rich graphical controls that contain, for example, animation and audio linked to an icon displayable on a computer monitor 132. The software interface 122 connects the user through control software 120 than in turn is connected in a controlling relation to such devices 110-114 as a light switch, a home entertainment device, an air conditioning/heating unit, a security system, an irrigation system, or an appliance. The control software 120 may comprise such software applications as are known in the art that are programmable by a user. The software interface 122 is dynamic in that it is adaptable for the addition or removal of controls without rebuilding or reinstalling. The software interface 122 is network enabled to act as a standard web server, and may use programmable web server applications that are known in the art to facilitate communications across the network 104 without requiring proprietary control signals. The client portion of the software interface of the invention 124 is hosted in a standard web browser such as those that are pre-installed in virtually all major computer operating systems designed for consumer purchase, and communicates with the server portion of the software interface through the network 104. The communication between the client software 124 and the server software 122 will not need the network 104 when the client software 124 and the server software 122 are on the same computer 100 as drawn in FIG. 1.

The client software 124 presents a plurality of icons 134-138 to the user on the monitor 132, and permits the deletion of these icons or the addition of another available, for example, from a template or a menu. The client software 124 is dynamic in that it is adaptable for the addition or removal of controls by receiving configuration signals from the server software 122 without the need for reinstalling or rebuilding, making the changes appear on the video monitor 132 without any user input required. Anywhere that network communications facilitated by the network 104, a plurality of users may each have a computer with the control software 124 currently loaded and running in a web browser, each having the same or a different set of control icons 134-138, and each able to control the devices 110-114 therewith.

The graphics of the software interface 124 are expandable and customizable, with a vector graphics platform, such as Flash RTM, being tem plated to allow third-party designers and end users to create their own interfaces without accessing the internal systems and connections to which their interfaces will be attached.

In addition, since the software interface 122 is network-enabled, external data may be made available to the computer 100 as desired, such as news headlines or interactive content that could, for example, complement the activities of one or more of the devices 110-114. As an example if a television program is being viewed on an educational topic, the user may be dynamically presented with a new icon containing multimedia presentations and choices for gathering further information about the topic.

The schematic diagram of the general layout shown in FIG. 2 illustrates the interaction between the client side 40 and the server side 50 components. The client may comprise, for example, a computer and a web browser that host a flash engine. The server may comprise a personal computer, for example. Here the user 41 interacts with the rich object control client 42, which itself interacts with the server side 50 rich object control service 51. This rich object control service 51 in turn access any of a plurality of supported third-party information systems, including, but not intended to be limited to, databases and data warehouses 52, a home automation system 53, a data management system 54, and targeted advertising system 55.

As shown in FIG. 3. the rich object control client 42 comprises a client engine 56 with an interface control 57 for interacting with the user 41. This control 57 handles receiving input from the user 41, presenting multimedia, text, and other elements to the user. The client engine 56 also functions to create and destroy an interface control 58.

Further detail is shown in FIG. 4, wherein the client engine 56 components are illustrated schematically. Within the engine 56 an interface control map service 59 performs interface control location mapping 60 and sends data to an interface control data polling service 61, which in turn sends data to a contact point 62 for sending data to the server service 51. The interface control map service 59 also interacts with an interface control loading service 63, which further communicates with the contact point 62 and performs the task of loading or unloading the interface control 58 into memory. The contact point 62 further communicates with an interface control data updating service 64 and a loaded interface control 57. The updating service 64 performs an additional task by keeping the current data transaction state 65 in memory.

The client-side engine 56 provides updates in the form of structured data to and from the components; polls the server to receive new updates from the server; discards any information sent from the server that is beyond the current transaction state; keeps transaction information to identify new transactions from the server, in case network latency sends or skips updates; identifies commands to load new components and loads them into a mapped memory location on the client; guarantees the loading and unloading of the control components; and identifies commands to unload components and unloads them from the mapped memory locations.

A more detailed schematic of the rich object control service 51 is illustrated in FIG. 5, wherein control is performed by a data request router 66, which communicates with a rich object control service interface 67, which in turn communicates with the rich object control client 42. Router 66 also communicates with a control state data store 68, which in turn communicates with a ROC control state 69. Router 66 further communicates with a client session manager 70, which in turn communicates with the current client session state 71.

The sector of the rich object control service 51 that performs the control operations, such as over a home automation system 53, includes two elements that communicate with the router 66: a ROC control 72 to real-time component mapping and service interface 73. These components 72, 73 both interact with an initialization service 74, which stores and retrieves data from a file system 75 with component templates and component instances. The ROC control 72 communicates with a component property mapping function 75.

The server side service 51 performs the following functions: accepts updates from the client engine 56, recording transaction nature of the client; tracks the usage of components on the client side to optimize output to the client when requesting the latest changes; supports an unlimited number of clients at the same time, up to hardware and system limitations of the equipment used; tracks updates from the information system transactions to enable the client to request information that is newer than the current state; sends updates to the client that have occurred since their last successful update request; sends changes to the control and data systems that come from clients; and identifies nonmapped instances of control classes in the automation system and creates the mappings and/or files from the class templates.

The client side 40 components and engine 56 run in a vector graphics format, in a preferred embodiment comprising a package such as Macromedia Flash, taking advantage of this environment's ability to package code, multimedia content, or both into packages that play in the Flash player. The engine 56 has been built into a series of self-contained shockwave flash (.SWF) files, a compiled version of the content for the Flash player. These components interact with the engine through a layer of standardized code that is dropped into a multimedia SWF file to enable the communication to and from the engine 56. This layer of code that enables components to communicate with the engine is substantially the same in all components; therefore, the developer needs to perform no work to develop a component SWF in order to communicate to the engine other than a simple “cut and paste” operation.

Another feature of the client-side engine 56 is a mechanism for guaranteeing that when an individual component is suppose to load, it actually does load, providing a valid connection can be made with the server 50. When this loading occurs, the engine 56 maps the memory location of the individual components. The engine later uses this map during its mechanism that polls the server for updates on behalf of all the currently loaded components. The map is used as a cache table to quickly distribute updates from the server to each component. The loading mechanism also records transaction information so that only new and changing information is sent to the components.

The server service contains a mechanism for providing data to the engine's polling requests for new data in an optimized format. Features of this mechanism include immediately forcing the connection closed when no new information needs to be sent to the client, filtering the information sent to the client that involves currently loaded components on the client. A different mechanism on the server accepts updates from the components so that connections for updates and connections for polling on a client machine can be done in parallel without conflict.

There also exists a mechanism to map incoming and outgoing data requests to the client back to the real-time data services and information systems. The mechanism uses a stored mapping of unique identifiers (GUID) for each user interface component, and maps each of its properties to an available information system's identifier and property. This mapping is made available to a specific information systems mechanism that is coded to interface with the application programming interface that is specific for that type of information system, and includes the necessary code to send and receive updates from that external system.

The server service also has an automatic component initialization mechanism for the home automation API interface or other information interfaces that uses an object oriented data class structure. This initialization mechanism uses the previously mentioned component to information system map to identify if a specific instance of a supported class in the home automation system is currently mapped to a component. If no mapping exists, then the mechanism creates the component using a GUID identifier on the file system of the server, and creates the necessary mappings in the component to information system mapping mechanism. This allows the class templates to be provided and then individual instances created on the fly without the need to manage a large collection of components while still providing the benefits of having one instance of a component that maps back to a specific instance of a real-time data point.

Other Embodiments

Other embodiments would have the same system as described in the preferred embodiment but would be implemented with differently controlled devices or combination of devices to enable products that have yet to be seen in the world.

One of these other embodiments includes installation of the present invention on a set-top cable box. Current set-top boxes are including processors, memory, and a storage system such as hard drive. Other embodiments of set-top technology include show guides and hard-drive storage for digitally recording television content for later playback, a.k.a. time shifting. These set-top boxes should soon include broadband connectivity to a home PC network that is now separately in devices provided by cable operators such as a cable modems. If this newly convergent device is used to house an embodiment of the invention, then a user with a connected network could extended control of the television tuner housed within the multi-function set top box to any web-browser enabled computer on their home network, or on the internet. Since in this configuration the television output serves the function of the monitor, and the remote control device is the input device for the system, the television and remote control become the primary user interface for the invention and control of the set-top box's functions. This ensures that the same user interface that is normally presented on-screen while in your home is the same interface that would be provided when connected via a PC in your house, or from another computing device anywhere in the world via the Internet.

In addition there could be an additional data provider connected to the system via a software interface from the TV tuner portion hardware to the invention. This data provider interface could provide information such as closed captioning text to the end user on a connected device in possession of a person instead of displaying on the television. This would allow multiple functions, such deliver personalized advertising in conjunction with a targeted advertising system that could be housed at the cable operator's data center. An example of this personalized advertising system would be a family watching a sitcom with a man, woman, and child exchanging dialog about Christmas presents. The advertising system could be connected to the Television's tuning, or time-shifted playback system, and the cable operator could deliver custom advertising about the shoes worn by the woman in the sitcom to the women in the house watching the television program, and similarly with the tie of the man in the sitcom, and the discussed Christmas presents that the child in the sitcom could be strategically targeted to those most likely to cause the item to be bought. The timing on the custom advertising could be based on time coding within the program. An already available time coding of content is available, the closed-caption now required on all television programs in the U.S. There is already known software and hardware systems that can extract the text of closed-caption signal, and creating a closed caption and television provider for the several different manufactures of set-top boxes would only require the extended software API to be written to interface those manufactures specific systems.

Another benefit is that the targeted advertising system could easily contain Internet links to allow the direct purchase of the items, or the cable operator could implement a purchase system by creating a software interface that is connected to the current invention's software API that allows the system to be extended.

In an extension of an embodiment, the system in addition to allowing the control of devices within the home would display the current utility usage for a household. Currently there exists wireless transceiver technology for utility meters such as power meters. This allows a device to be hand held or car mounted by a representative of the power company to come in close proximity and identify the customer and their current power consumption. By placing the wireless receiver as a connected device inside the home as in FIG. 1 108, the presentation invention would allow daily monitoring of the power consumption and allow the occupants to monitor their current expenditure of power, and control and curb their use of power from the same software interface. The same could be done for utility usages. In addition, if the embodiment of the invention is that of the above mentioned set-top box connected to a cable operator with two-way network communications, the power meter reading could be reported through the network, eliminating the need for a close proximity visit by the power company representative.

Herein real-time data point is used to describe a point of data in an information system or other supported system in its current state as reported by that system's API and event structure.

In the foregoing descriptions, certain terms have been used for brevity, clarity, and understanding, but no unnecessary limitations are to be implied therefrom beyond the requirements of the prior art, because such words are used for descriptive purposes herein and are intended to be broadly construed. Moreover, the embodiments of the apparatus illustrated and described herein are by way of example, and the scope of the invention is not limited to the exact details of the construction.

Conclusion

The present invention converges elements of hardware control systems; software interfaces; network communication; and graphic design to present a reliable, adaptable, dynamic, customizable multi-media enabled interface capable of monitoring and controlling connected devices. This same interface as customized by the user, can be used on a television, appliance, PDA, or other network connected devices anywhere in the world across the Internet with standard web browsing software.

While my above description contains many specificities, these should not be construed as limitations on the scope of the invention, but rather as an exemplification of the preferred embodiment and other embodiments described. Many other variations are possible. For example, except for wires for powered appliances, an all-wireless environment is possible wherein all configuration & control signals and all network communications are across wireless connections. Another example would implementing the invention on a new computing system with combinational advances in merging processor, memory, and software storage into one device that operates in an equivalent manner as a computer such as the Cursoe RTM processor from Transmeta Corporation.

What is claimed is:

1. A software interface installable on a processor for interfacing with an electrically or electronically controllable device comprising:
a) means for receiving input from a user remotely via network;
b) means for translating the network-communicated user input into at least one of a control signal or a configuration signal;
c) means for communicating a control signal via to control software in controlling relation to at least one of an electrically or an electronically controllable device through a hardware interface; and
d) means for translating a configuration signal into a user interface application between the control software and an indicator symbol displayable to the user.

2. An information processing apparatus in a client-server environment comprising a presentation layer program to display a plurality of icons comprising the steps of:
a) continuously accessing a provider using state information to retrieve content a associated with displayed icons, wherein said state information is maintained by the provider and said state information indicates content associated with the currently displayed icons in the presentation layer which the server wishes to transmit to the client presentation layer;
b) generating at least one instruction to update the display of the icon based on content obtained from the provider in step (a);
c) receiving at least one command request via user input enabling the transmission of information to the provider that includes the unique identification of an icon associated with the user input and the type of command; and
d) transmitting said information associated with a user command request to the provider;

3. A software interface installable on a processor for interfacing with a user comprising:
a) a means for displaying at least one of a plurality of icon;
b) a means for communicating with a server program on either a timed interval or immediately when user input is detected wherein such communication is transmitted by the hypertext transfer protocol;
c) a means for displaying a new icon without user input when a communication from the server program contains information to display new icons;
d) a means for changing the content or display of an icon when information associated with that icon is received from the server program; and
e) means of transactional integrity to insure that the latest state information associated with the displayed icons from the server is not replaced by earlier information;
